(19) United States
(12) Patent Application Publication
(10) Pub. No.: US 2026/0154185 A1
(43) Pub. Date: Jun. 4, 2026

(54) METHOD FOR PERFORMING UNIT TEST GENERATION WITH AID OF MULTIPLE ARTIFICIAL INTELLIGENCE AGENTS

(71) Applicant: MEDIATEK INC., Hsinchu City (TW)

(72) Inventors: En Jen, Hsinchu City (TW); Po-Wei Tseng, Hsinchu City (TW); Heng Li, Hsincu City (TW); Shao-Yun Liu, Hsinchu City (TW); Chin-Tang Lai, Hsinchu City (TW); Chia-Shun Yeh, Hsinchu City (TW)

(73) Assignee: MEDIATEK INC., Hsinchu City (TW)

(21) Appl. No.: 18/967,660

(22) Filed: Dec. 4, 2024

(51) Int. Cl. G06F 11/3668

(52) U.S. Cl. CPC G06F 11/3684

(57) ABSTRACT

A method for performing unit test (UT) generation with aid of multiple artificial intelligence (AI) agents includes: receiving a target function; generating, by a first AI agent, a target test condition according to the target function; retrieving, by a second AI agent, a coarse UT from a first database according to the target function, wherein the first database comprises multiple candidate UTs, and the coarse UT is one of the multiple candidate UTs; and performing, by a third AI agent, a refining operation according to the target test condition and the coarse UT in order to generate a refined UT.

### BACKGROUND

The present invention is related to a unit test (UT), and more particularly, to a method for utilizing multiple large language models (LLMs) to automatically generate the UT with aid of retrieval-augmented generation (RAG) and supervised fine-tuning (SFT).

Generating a UT for verifying whether a program meets customer requirements is a key factor for maintaining the program quality. For an existing method, the UT is manually written by an engineer, which requires a lot of expertise and is quite time-consuming. It may be labor-intensive to collect UT data of different modules since each module may require different UT architecture. In addition, the data quality of the collected UT data cannot be guaranteed, and performing additional pre-processing and fine-tuning operations upon the collected UT data may be quite complicated and cannot guarantee the quality of performance.

### SUMMARY

It is therefore one of the objectives of the present invention to provide a method for performing UT generation with aid of multiple artificial intelligence (AI) agents and an associated non-transitory machine-readable medium for storing a program code that performs the method when executed, in order to address the above-mentioned issues.

According to an embodiment of the present invention, a method for performing UT generation with aid of multiple AI agents is provided. The method comprises: receiving a target function; generating, by a first AI agent, a target test condition according to the target function; retrieving, by a second AI agent, a coarse UT from a first database according to the target function, wherein the first database comprises multiple candidate UTs, and the coarse UT is one of the multiple candidate UTs; and performing, by a third AI agent, a refining operation according to the target test condition and the coarse UT in order to generate a refined UT.

According to an embodiment of the present invention, a non-transitory machine-readable medium for storing a program code is provided, wherein when loaded and executed by a processor, the program code instructs the processor to perform a method for performing UT generation with aid of multiple AI agents, and the method comprises: receiving a target function; generating, by a first AI agent, a target test condition according to the target function; retrieving, by a second AI agent, a coarse UT from a first database according to the target function, wherein the first database comprises multiple candidate UTs, and the coarse UT is one of the multiple candidate UTs; and performing, by a third AI agent, a refining operation according to the target test condition and the coarse UT in order to generate a refined UT.

One of the benefits of the present invention is that, by the method of the present invention, after a target function is received, a corresponding UT can be automatically generated by executing multiple AI agents with aid of retrieval-augmented generation (RAG) and supervised fine-tuning (SFT), which can greatly improve the build pass ratio and the coverage ratio of the UT and shorten the time for generating the UT.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating implementation details of multiple AI agents according to an embodiment of the present invention.

FIG. 3 is a flow chart of a method for performing UT generation with aid of multiple AI agents according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

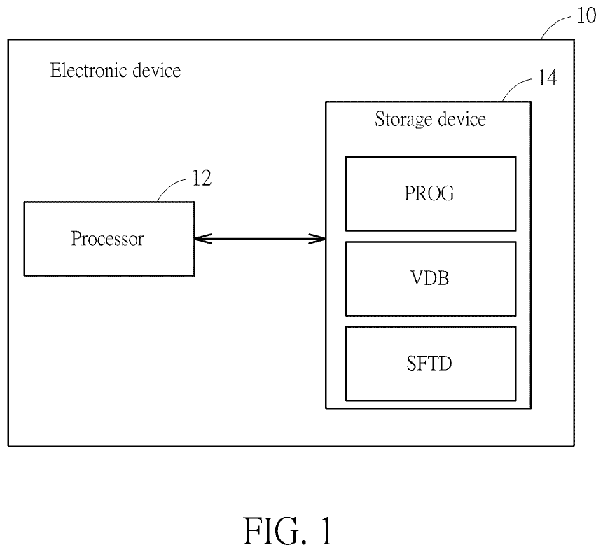

FIG. 1 is a diagram illustrating an electronic device 10 according to an embodiment of the present invention. By way of example, but not limitation, the electronic device 10 may be a tablet computer or a personal computer (e.g., a desktop computer and a laptop computer). The electronic device 10 may include a processor 12 and a storage device 14 (e.g., a memory). The processor 12 may be a single-core processor or a multi-core processor. The storage device 14 is a non-transitory machine-readable medium, and is arranged to store a computer program code PROG, a vector database VDB, and a supervised fine-tuning (SFT) database SFTD.

The processor 12 is equipped with software execution capability. When loaded and executed by the processor 12, the computer program code PROG instructs the processor 12 to execute multiple artificial intelligence (AI) agents, and perform a method for performing unit test (UT) generation with aid of the AI agents. The electronic device 10 may be regarded as a computer system using a computer program product that includes a computer-readable medium containing the computer program code PROG. Regarding the method as proposed by the present invention, it may be embodied on the electronic device 10.

In response to a target function TAR_FUN to be tested being received by the processor 12, the processor 12 may execute the AI agents in order to automatically generate a corresponding UT according to the target function TAR_FUN. For example, the UT generation process may be divided into three stages (e.g., stages STA1, STA2, and STA3), wherein each stage may be performed by a dedicated AI agent.

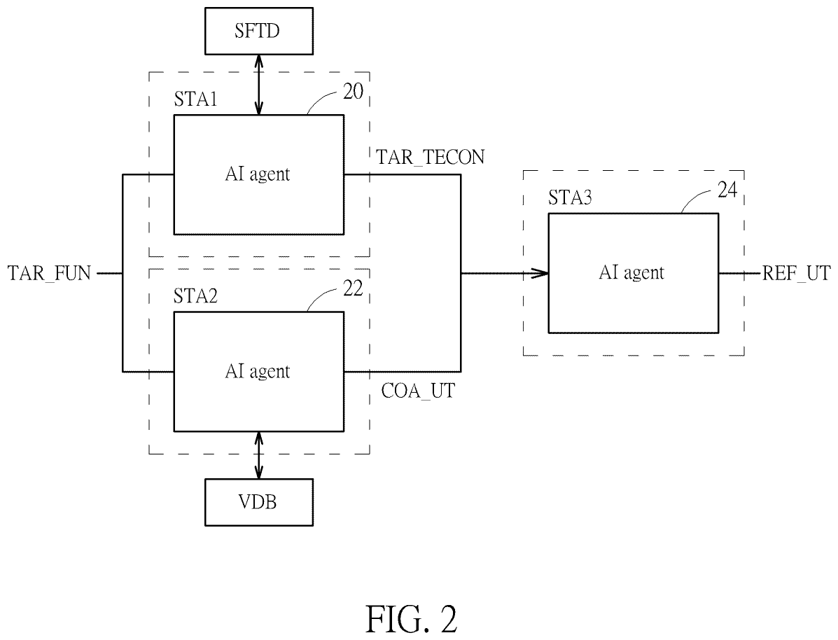

FIG. 2 is a diagram illustrating implementation details of multiple AI agents 20, 22, and 24 according to an embodiment of the present invention. As shown in FIG. 2, the stage STA1 is performed by the AI agent 20, the stage STA2 is performed by the AI agent 22, and the stage STA3 is performed by the AI agent 24. Each of the AI agents 20, 22, and 24 may be a large language model (LLM).

In the stage STA1, the AI agent 20 may generate a target test condition TAR_TECON according to the target function TAR_FUN. More particularly, the SFT database SFTD may include data associated with multiple test conditions, and an SFT operation may be performed upon the AI agent 20 according to the SFT database SFTD, in order to generate a fine-tined AI agent for generating the target test condition TAR_TECON. That is, the AI agent 20 may be an SFT LLM. It should be noted that, after a certain amount of new data related to the test conditions is collected, the SFT database SFTD can be updated according to the collected data, and the AI agent 20 can be continually fine-tuned according to the updated SFT database SFTD.

The vector database VDB may store multiple numerical values corresponding to multiple candidate UTs in advance. In the stage STA2, the AI agent 22 may retrieve a coarse UT COA_UT from the vector database VDB according to the target function TAR_FUN, wherein the coarse UT COA_UT may be one of the candidate UTs. Specifically, retrieval-augmented generation (RAG) and in-context learning (ICL) may be applied on the AI agent 22 for performing the retrieving operation.

In the stage STA3, the target test condition TAR_TECON and the coarse UT COA_UT may be input to the AI agent 24, and the AI agent 24 may perform a refining operation according to the target test condition TAR_TECON and the coarse UT COA_UT in order to generate a refined UT REF_UT. In detail, the AI agent 24 may perform a pre-processing operation upon the target test condition TAR_TECON and the coarse UT COA_UT in order to generate a pre-processing result PRE_RES, generate a prompt PMT according to the pre-processing result PRE_RES, and generate the refined UT REF_UT according to the prompt PMT. It should be noted that, the prompt PMT may be a Chain-of-Thought (CoT) prompt. For example, according to the pre-processing result PRE_RES, a CoT approach may be performed upon the AI agent 24 for generating the CoT prompt.

After the refined UT REF_UT is generated, the processor 12 may be further arranged to execute the computer program code PROG to evaluate the refined UT REF_UT for generating an evaluation result EVA_RES, and determine whether the evaluation result EVA_RES meets a criterion. In response to the evaluation result EVA_RES meeting the criterion, the refined UT REF_UT may be output into an auto-evaluation server AE_SER for performing verification and generating a corresponding coverage ratio and a corresponding build pass ratio. In response to the evaluation result EVA_RES not meeting the criterion, the AI agent 24 may be further arranged to adjust the prompt PMT for regenerating the refined UT REF_UT until the evaluation result EVA_RES meets the criterion. In this way, under a situation that the evaluation result EVA_RES does not meet the criterion, there is no need to output the refined UT REF_UT into the auto-evaluation server AE_SER, which can save the additional time for verifying the refined UT REF_UT.

In some embodiments, after the refined UT REF_UT is generated, a user may directly determine whether the refined UT REF_UT meets the user expectation. If Yes, the refined UT REF_UT may be directly output into the auto-evaluation server AE_SER for performing subsequent processing; if No, the AI agent 24 may be notified to adjust the prompt PMT until the refined UT REF_UT meets the user expectation. In this way, the user can immediately intervene in the evaluation process of the UT generation in order to ensure correctness and/or comprehensiveness of the refined UT REF_UT generated by the AI agent 24.

Compared with a case where a native LLM is utilized to generate a UT according to the target function TAR_FUN, the method of the present invention may greatly improve the build pass ratio and the coverage ratio of the UT according to the AI agents 20, 22, and 24 with aid of the RAG and the SFT. In addition, the time for generating the UT can be significantly shortened.

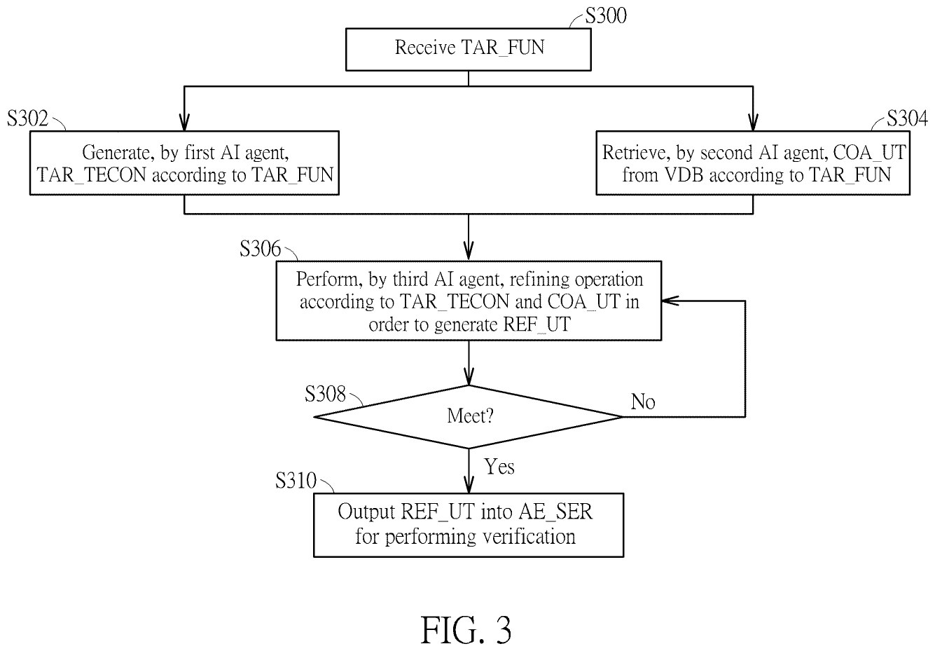

FIG. 3 is a flow chart of a method for performing UT generation with aid of multiple AI agents according to an embodiment of the present invention. Provided that the result is substantially the same, the steps are not required to be executed in the exact order shown in FIG. 3. For example, the method shown in FIG. 3 may be employed by the electronic device 10 shown in FIG. 1 (more particularly, the processor 12) and the executed AI agents 20, 22, and 24 shown in FIG. 2.

In Step S300, the target function TAR_FUN to be tested is received.

In Step S302, by the AI agent 20, the target test condition TAR_TECON is generated according to the target function TAR_FUN.

In Step S304, by the AI agent 22, the coarse UT COA_UT is retrieved from the vector database VDB according to the target function TAR_FUN.

In Step S306, by the AI agent 24, a refining operation is performed according to the target test condition TAR_TECON and the coarse UT COA_UT in order to generate the refined UT REF_UT.

In Step S308, it is determined whether the refined UT REF_UT meets a criterion. If Yes, Step S310 is entered; if No, Step S306 is returned for adjusting the prompt PMT in order to regenerate the refined UT REF_UT.

In Step S310, the refined UT REF_UT is output into the auto-evaluation server AE_SER for performing verification.

In summary, by the method of the present invention, after a target function is received, a corresponding UT can be automatically generated by executing multiple AI agents with aid of the RAG and the SFT, which can greatly improve the build pass ratio and the coverage ratio of the UT and shorten the time for generating the UT.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing unit test (UT) generation with aid of multiple artificial intelligence (AI) agents, comprising:
receiving a target function;
generating, by a first AI agent, a target test condition according to the target function;
retrieving, by a second AI agent, a coarse UT from a first database according to the target function, wherein the first database comprises multiple candidate UTs, and the coarse UT is one of the multiple candidate UTs; and
performing, by a third AI agent, a refining operation according to the target test condition and the coarse UT in order to generate a refined UT.

2. The method of claim 1, wherein each of the first AI agent, the second AI agent, and the third AI agent is a large language model (LLM).

3. The method of claim 2, wherein the first AI agent is a supervised fine-tuning (SFT) LLM.

4. The method of claim 1, wherein the step of generating, by the first AI agent, the target test condition according to the target function further comprises:
performing a supervised fine-tuning operation upon the first AI agent according to a second database, in order to generate a fine-tuned AI agent for generating the target test condition, wherein the second database comprises data associated with multiple test conditions.

5. The method of claim 1, wherein the step of retrieving, by the second AI agent, the coarse UT from the first database according to the target function comprises:
applying a retrieval-augmented generation (RAG) and an in-context learning (ICL) on the second AI agent for retrieving the coarse UT from the first database.

6. The method of claim 1, wherein the step of performing, by the third AI agent, the refining operation according to the target test condition and the coarse UT in order to generate the refined UT comprises:
performing, by the third AI agent, a pre-processing operation upon the target test condition and the coarse UT in order to generate a pre-processing result;
generating, by the third AI agent, a prompt according to the pre-processing result; and
generating, by the third AI agent, the refined UT according to the prompt.

7. The method of claim 6, wherein the prompt is a Chain-of-Thought (CoT) prompt.

8. The method of claim 7, wherein the step of generating, by the third AI agent, the prompt according to the pre-processing result further comprises:
according to the pre-processing result, performing a CoT approach upon the third AI agent for generating the CoT prompt.

9. The method of claim 1, further comprising:
evaluating the refined UT in order to generate an evaluation result; and
determining whether the evaluation result meets a criterion.

10. The method of claim 9, wherein the step of determining whether the evaluation result meets the criterion further comprises:
in response to the evaluation result meeting the criterion, outputting the refined UT into an auto-evaluation server for performing verification; and
in response to the evaluation result not meeting the criterion, adjusting, by the third AI agent, the prompt for regenerating the refined UT.

11. A non-transitory machine-readable medium for storing a program code, wherein when loaded and executed by a processor, the program code instructs the processor to perform a method for performing unit test (UT) generation with aid of multiple artificial intelligence (AI) agents, and the method comprises:
receiving a target function;
generating, by a first AI agent, a target test condition according to the target function;
retrieving, by a second AI agent, a coarse UT from a first database according to the target function, wherein the first database comprises multiple candidate UTs, and the coarse UT is one of the multiple candidate UTs; and
performing, by a third AI agent, a refining operation according to the target test condition and the coarse UT in order to generate a refined UT.

12. The non-transitory machine-readable medium of claim 11, wherein each of the first AI agent, the second AI agent, and the third AI agent is a large language model (LLM).

13. The non-transitory machine-readable medium of claim 12, wherein the first AI agent is a supervised fine-tuning (SFT) LLM.

14. The non-transitory machine-readable medium of claim 11, wherein the step of generating, by the first AI agent, the target test condition according to the target function further comprises:
performing a supervised fine-tuning operation upon the first AI agent according to a second database, in order to generate a fine-tuned AI agent for generating the target test condition, wherein the second database comprises data associated with multiple test conditions.

15. The non-transitory machine-readable medium of claim 11, wherein the step of retrieving, by the second AI agent, the coarse UT from the first database according to the target function comprises:
applying a retrieval-augmented generation (RAG) and an in-context learning (ICL) on the second AI agent for retrieving the coarse UT from the first database.

16. The non-transitory machine-readable medium of claim 11, wherein the step of performing, by the third AI agent, the refining operation according to the target test condition and the coarse UT in order to generate the refined UT comprises:
performing, by the third AI agent, a pre-processing operation upon the target test condition and the coarse UT in order to generate a pre-processing result;
generating, by the third AI agent, a prompt according to the pre-processing result; and
generating, by the third AI agent, the refined UT according to the prompt.

17. The non-transitory machine-readable medium of claim 16, wherein the prompt is a Chain-of-Thought (CoT) prompt.

18. The non-transitory machine-readable medium of claim 17, wherein the step of generating, by the third AI agent, the prompt according to the pre-processing result further comprises:
according to the pre-processing result, performing a CoT approach upon the third AI agent for generating the CoT prompt.

19. The non-transitory machine-readable medium of claim 11, wherein the method further comprises:
evaluating the refined UT in order to generate an evaluation result; and
determining whether the evaluation result meets a criterion.

20. The non-transitory machine-readable medium of claim 19, wherein the step of determining whether the evaluation result meets the criterion further comprises:
in response to the evaluation result meeting the criterion, outputting the refined UT into an auto-evaluation server for performing verification; and
in response to the evaluation result not meeting the criterion, adjusting, by the third AI agent, the prompt in order to regenerate the refined UT.
